(19) United States
(12) Patent Application Publication
(10) Pub. No.: US 2015/0136084 A1
(43) Pub. Date: May 21, 2015

(54) FUEL DISTRIBUTOR

(71) Applicants: Martin Maier, Meoglingen (DE); Martin Goehner, Vaihingen (DE); Markus Feigl, Markgroeningen (DE); Helmut Schneider, Aichtal (DE); Nikolaus Hautmann, Ditzingen (DE); Dietmar Uhlenbrock, Stuttgart (DE); Holger Uhrig, Memmelsdorf (DE)

(72) Inventors: Martin Maier, Meoglingen (DE); Martin Goehner, Vaihingen (DE); Markus Feigl, Markgroeningen (DE); Helmut Schneider, Aichtal (DE); Nikolaus Hautmann, Ditzingen (DE); Dietmar Uhlenbrock, Stuttgart (DE); Holger Uhrig, Memmelsdorf (DE)

(21) Appl. No.: 14/357,364

(22) PCT Filed: Oct. 4, 2012
(86) PCT No.: PCT/EP2012/069555

§ 371 Date: May 9, 2014

(30) Foreign Application Priority Data
Nov. 11, 2011 (DE) 10 2011 086 209.9

(51) Int. Cl. F02M 55/02

(52) U.S. Cl. CPC F02M 55/02
USPC 123/452

(57) ABSTRACT

A fuel distributor, which is used in particular for fuel injection systems of mixture-compressing spark ignition internal combustion engines, includes a tubular base body, a first holder and a second holder. The first holder is connected here to the tubular base body at a first fastening point of the tubular base body. The second holder is also connected to the tubular base body at a second fastening point of the tubular base body. The tubular base body has at least one bend at least between the first fastening point and the second fastening point. A base body having a meandering pattern may be implemented in this way, enabling adjustment of thermal changes in the length of a cylinder head on which the fuel distributor is mounted.

### FIELD

The present invention relates to a fuel distributor, which is used in particular for fuel injection systems of mixture-compressing spark-ignition internal combustion engines. The present invention relates in particular to the field of fuel injection systems designed as medium-pressure systems.

### BACKGROUND INFORMATION

It is possible that a fuel distributor rail made of steel or aluminum for high-pressure applications is used in fuel injection systems in motor vehicles. A compressive strength for pressures of 20 MPa (200 bar) may be achieved in this way. However, this massive design of the rail, which is suitable for high-pressure applications, is associated with high manufacturing costs.

Furthermore, fuel distributor rails for low-pressure applications of 0.3 MPa (3 bar) to 0.5 MPa (5 bar) may be used for applications in this regard. Thin-walled steel or plastic pipes made of PA or PPS, for example, may be used to manufacture the fuel distributor rails. However, the range of application of such fuel distributor rails for low-pressure applications is limited to the aforementioned low-pressure range.

In the manufacture of a fuel distributor rail of steel, a steel pipe may be used as the base; individual components such as end caps, screw-on holders, high-pressure connections and interfaces to the injectors are soldered onto such a steel pipe. When the fuel injection system is installed, the high-pressure rail made of steel is mounted on a cylinder head, which is generally made of aluminum, of an internal combustion engine. When the engine heats up during operation, stresses develop in the high-pressure rail since the aluminum cylinder head expands more than the steel pipe of the high-pressure rail. The wall must therefore be designed to be relatively thick since both the internal pressure and the longitudinal elongation must be accommodated. Such a design of the high-pressure rail is therefore expensive to manufacture.

For other reasons, the manufacture of a high-pressure rail is generally expensive. For example, a drawn pipe must be cut to length during manufacturing, the ends must be machined and the outlets must be bored. Furthermore, the interfaces to the injector and the holders are generally manufactured from reworked cast steel parts or small assembly groups or deep-drawn parts. The connecting parts may be designed as turned parts or deep-drawn parts, while the high-pressure connections are turned parts. Add-on parts must also be secured before the final soldering operation. Overall this is a highly cost-intensive manufacturing process involving many operating steps.

### SUMMARY

An example fuel distributor in accordance with the present invention may have the advantage that the design and manufacturability are improved. Specifically a fuel distributor suitable for the desired pressure, in particular medium pressure, may be created at a comparatively low manufacturing cost. The cost of materials required with respect to compressive strength may be reduced in this process.

Relative changes in length between the tubular base body and a cylinder head in the installed state of the fuel distributor may be compensated advantageously through the design of the tubular base body. The tubular base body is put under load in this way mainly by the internal pressure, so that the wall thickness of the tubular base body may be reduced. This reduces the use of materials. Manufacturing is also simplified in this way.

It may be advantageous if the tubular base body has precisely one bend between the first fastening point and the second fastening point. Manufacturing from a small number of parts is possible with a multipart design of the tubular base body in particular, so that the number of connecting points is also reduced.

However, it may also be advantageous if the tubular base body has a first bend and at least one second bend between the first fastening point and the second fastening point, and that the second bend is curved in the opposite direction from the first bend. This makes it possible to have a design optimized to the installation space. Furthermore, advantageous flexibility over the bends is achieved to compensate for thermal changes in length, for example. It is also advantageous here that the tubular base body has a straight section between the first bend and the second bend. This permits a design of the tubular base body using identical parts. The bends may be identical parts in particular.

It may be advantageous if the tubular base body has a third bend between the first fastening point and the second fastening point, that the second bend is situated between the first bend and the third bend, and that the first bend and the third bend are curved in the same direction. The flexibility of the tubular base body may be further improved in this way to compensate for thermal changes in length. It is also possible for the first and third bends to be designed as identical parts here.

It may also be advantageous if the tubular base body has a straight section at the first fastening point and/or that the tubular base body has a straight section at the second fastening point. First of all, the processing of individual parts is facilitated in this way. For example, a stable bore may be designed in the straight section. Furthermore, fastening of the holder to the straight section of the tubular base body is facilitated, which may be accomplished via a connecting section, for example.

It may also be advantageous if no other holder is connected to the tubular base body between the first fastening point and the second fastening point. This prevents additional holding forces from being introduced into the tubular base body.

It may also be advantageous if the first holder is connected to the tubular base body via a first connecting section at the first fastening point, that the second holder is connected to the tubular base body via a second connecting section at the second fastening point, that a first fuel channel is formed which opens from a fuel chamber of the tubular base body into an interior of the first holder, and that a second fuel channel is formed which opens from the fuel chamber of the tubular base body into an interior of the second holder.

Matching through-holes in the tubular base body at the fastening points and at the connecting sections may be formed for the design of the fuel channels. Such through-holes may also be designed to be oval or elongated holes to increase the general strength. The fuel channels also need not necessarily be designed with a circular cross section. The connecting sections also permit a fastening of the tubular base body to be adapted to the particular application case in this way. For example, the tubular base body may be above the connecting section or at the side of the connecting section with respect to its installed position. An arrangement of the tubular base body in which it is higher than the holder is preferably selected here. Furthermore, the tubular base body need not necessarily be in a plane above the holders parallel to a top side of a cylinder head.

Furthermore, it may be advantageous if a first cup, which is partially inserted into the interior of the first connecting section, is provided, and that a second cup, which is partially inserted into the interior of the second connecting section, is also provided. Fuel injectors of the fuel injection system may then be attached to the cups. Fuel may be carried into the fuel injectors from the fuel chamber of the tubular base body via the connecting sections in this way. Changes in the length of the cylinder head, which occur during operation, i.e., changes in the distances between the fuel injectors, may then be compensated through the design of the tubular base body.

Furthermore, it may be advantageous if the tubular base body is designed as a tubular base body bent in a meandering pattern and/or that one or multiple additional holders are provided, these holders being connected at least indirectly to the tubular base body at one or multiple fastening points of the tubular base body. It is possible in this way to implement a design which has a number of holders corresponding to the number of injectors, thus making a length adjustment possible due to the meandering pattern of the tubular base body.

### BRIEF DESCRIPTION OF THE DRAWINGS

Preferred exemplary embodiments of the present invention are explained in greater detail below with reference to the figures in which corresponding elements are provided with corresponding reference numerals.

FIG. 1 shows a fuel distributor in a schematic three-dimensional view corresponding to a first exemplary embodiment of the present invention.

FIG. 2 shows in extract a sectional view of the fuel distributor of the first exemplary embodiment of the present invention shown in FIG. 1.

FIG. 3 shows in extract a sectional view of a fuel distributor to illustrate a second exemplary embodiment of the present invention.

FIG. 4 shows in extract a sectional view of a fuel distributor to illustrate a third exemplary embodiment of the present invention.

### DETAILED DESCRIPTION OF EXAMPLE EMBODIMENTS

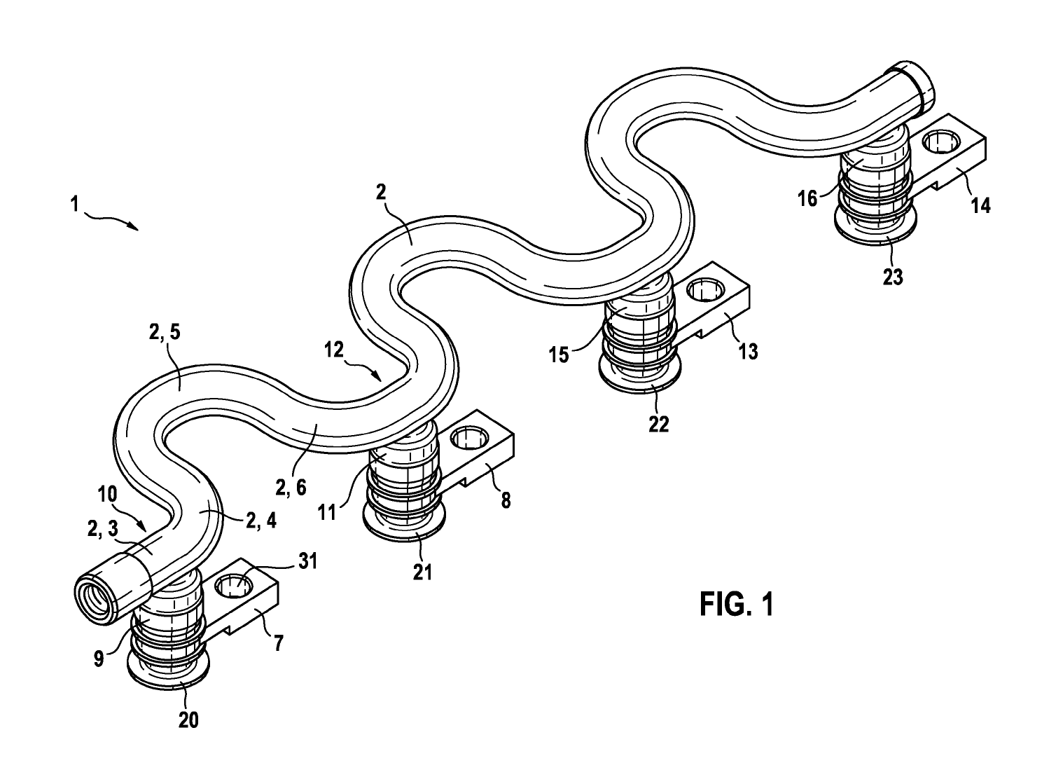

FIG. 1 shows a fuel distributor 1 in a schematic three-dimensional view corresponding to a first exemplary embodiment of the present invention. Fuel distributor 1 may be used in particular for fuel injection systems of mixture-compressing spark-ignition internal combustion engines. In particular fuel distributor 1 here is suitable for a medium-pressure system.

The medium pressure for such a medium-pressure system may be in the range of 3 MPa to 10 MPa or 30 bar to 100 bar. The medium pressure may be in the range of 5 MPa to 7 MPa or 50 bar to 70 bar in particular. However, example fuel distributor 1 according to the present invention is also suitable for other applications.

Fuel distributor 1 has a tubular base body 2. Tubular base body 2 includes a straight section 3, a first bend 4, a second bend 5 and a third bend 6. Furthermore, tubular base body 2 has additional bends, but to simplify the diagram, only bends 4 through 6 are identified.

Fuel distributor 1 also has a first holder 7 and a second holder 8. First holder 7 is connected to tubular base body 2 via a first connecting section 9 at a first fastening point 10. In this exemplary embodiment, first connecting section 9 is connected to straight section 3. Second holder 8 is connected to tubular base body 2 via a second connecting section 11 at a second fastening point 12.

First bend 4, second bend 5 and third bend 6 are situated between first fastening point 10 and second fastening point 12. No additional holders are connected to tubular base body 2 between fastening points 10, 12. However, additional holders 13, 14, which are connected to tubular base body 2 via connecting sections 15, 16, are also provided.

Fuel distributor 1 also has a first cup 20, a second cup 21 and additional cups 22, 23. First cup 20 is connected to first connecting section 9. Second cup 21 is connected to second connecting section 11. Additional cups 22, 23 are connected to connecting sections 15, 16. Fuel injectors of a fuel injection system are connectable to fuel distributor 1 at cups 20 through 23.

During operation, the distances between holders 7, 8, 13, 14 and connecting sections 9, 11, 15, 16 are determined by the geometry of the internal combustion engine, in particular a cylinder head. Tubular base body 2 is preferably made of steel for strength reasons. With respect to a cylinder head made of aluminum, for example, relative changes in length, which may result in stresses in tubular base body 2 of fuel distributor 1, occur with changes in temperature. For example, the length between holders 7, 8 and connecting sections 9, 11 may be adjusted because of a certain elasticity due to bends 4, 5, 6. This reduces the mechanical load on tubular base body 2.

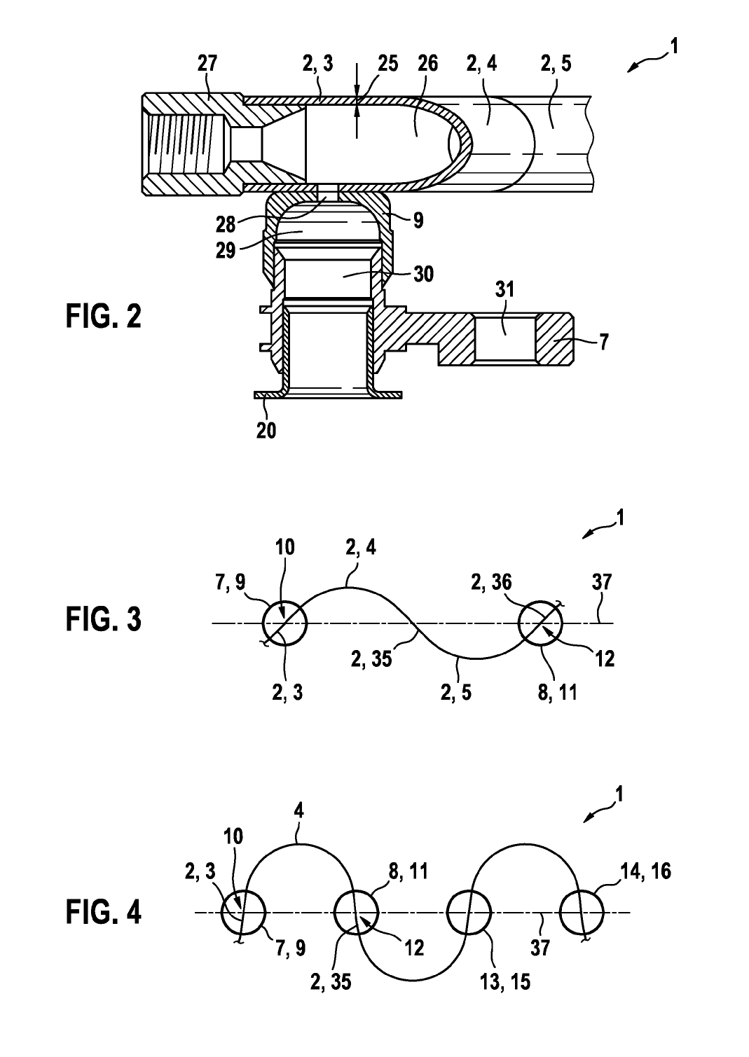

The design of fuel distributor 1 is also described below with reference to FIG. 2.

FIG. 2 shows fuel distributor 1 illustrated in FIG. 1 in a schematic sectional view shown in extract. Tubular base body 2 has a wall thickness 25. Since the length may be adjusted via bends 4 through 6 of tubular base body 2, the mechanical load on tubular base body 2 results generally from the fuel pressure of a fuel in fuel chamber (interior) 26 of tubular base body 2. Wall thickness 25 may thus be reduced. Fuel may be supplied to fuel chamber 26 through a hydraulic connection 27 during operation. Hydraulic connection 27 is connected to tubular base body 2. A first fuel channel 28 is formed between fuel chamber 26 in the interior of tubular base body 2 and an interior 29 of first connecting section 9. In this exemplary embodiment, one borehole is provided in tubular base body 2 and one borehole is provided in first connecting section 9 for this purpose. First fuel channel 28 may have a circular cross section. However, the cross section of first fuel channel 28 may also designed to be oval or as an elongated hole to increase the strength. A corresponding second fuel channel is formed between tubular base body 2 and second connecting section 11. Fuel chamber 26 is connected to an interior of second connecting section 11 via the second fuel channel.

Interior 29 of connecting section 9 leads into an interior 30 of first holder 7. Cup 20 is inserted into interior 30 of first holder 7. Fuel from fuel chamber 26 may thus be carried through interior 29 of connecting section 9 and interior 30 of first holder 7 to the fuel injector mountable on first cup 20.

In this exemplary embodiment, second bend 5 is situated between first bend 4 and third bend 6, first bend 4 and third bend 6 being curved in the same direction. Second bend 5 is curved in the opposite direction from first bend 4. This yields a meandering pattern of tubular base body 2.

In this exemplary embodiment, tubular base body 2 is situated directly on connecting section 15 in the installed position. However, tubular base body 2 may also be situated laterally above and below. Furthermore, tubular base body 2 may be fittingly installed rotated about a longitudinal axis by a large angle. This permits a compatible design for different installation spaces.

In this exemplary embodiment, cup 20 is plugged into holder 7. Holder 7 is in turn plugged into connecting section 9. This yields a form-fitting connection. The individual parts of tubular base body 2 may be tack-welded and soldered in one joining operation. The other elements of fuel distributor 1 may also be connected accordingly.

In this exemplary embodiment, holder 7 has a borehole 31 to enable it to be screwed onto the cylinder head. The fuel injector may be fastened to cup 20 via an O-ring, for example.

FIG. 3 shows in extract a schematic view of a fuel distributor 1 to illustrate a second exemplary embodiment of the present invention. First holder 7 is shown here with first connecting section 9, and second holder 8 is shown with second connecting section 11 as well as tubular base body 2. In this exemplary embodiment, tubular base body 2 has a first bend 4 and a second bend 5, which curve in opposite directions from one another. Straight sections 3, 35, 36 are also provided. Straight section 3, first bend 4, straight section 35, second bend 5, straight section 36 and additional elements are assembled successively, one after the other, to form tubular base body 2. Straight section 35 is thus situated between bends 4, 5. In this exemplary embodiment, only two bends 4, 5 and straight section 35 are provided between holders 7, 8 and first fastening point 10 and second fastening point 12. Straight sections 3, 35, 36 each have a non-disappearing angle to a mounting longitudinal axis 37 of tubular base body 2. Tubular base body 2 thus meanders back and forth around mounting longitudinal axis 37 and reaches mounting longitudinal axis 37 at cups 20, 21, which are connected to holders 7, 8.

FIG. 4 shows in extract a schematic view of fuel distributor 1 to illustrate a third exemplary embodiment of the present invention. In this exemplary embodiment, tubular base body 2 has only one bend 4 between holders 7, 8 and fastening points 10, 12. In this exemplary embodiment, bend 4 is designed as a half pipe-bend 4. A high flexibility is achieved along mounting longitudinal axis 37 to permit an adjustment of length in this way.

In particular in the exemplary embodiments described with reference to FIGS. 3 and 4, a horizontal installation, i.e., an arrangement of tubular base body 2 in a plane parallel to a top side of the cylinder head, is advantageous.

A change in length along mounting longitudinal axis 37, which occurs during operation, may be in the range of a few hundredths of a millimeter, for example. Such an elongation of length may be accommodated due to the meandering pattern of tubular base body 2. Specific embodiments adapted to the given application case are possible here, so that the corresponding design approach may be adapted to the limited available installation space, which is different for each individual engine. Wall thickness 25 here may be reduced significantly. This therefore reduces the manufacturing cost and the component weight. As in the case of a rail body made of a straight pipe, a favorable configuration of holders 7, 8, 13, 14 situated centrally beneath tubular base body 2 is achievable through this meandering pattern. Furthermore, identical parts may be used during manufacturing. This relates to holders 7, 8, 13, 14, bends 4 through 6, straight sections 3, 35, 36 and also cups 20 through 23 as well as connecting sections 9, 11, 15, 16. The basic geometry of tubular base body 2 may also be adapted to different engines here with little effort. For example, the curves of bends 4 through 6 may be adapted. A configuration and design of boreholes 31 on tubular base body 2, which is individualized for each engine, are also possible. The type of pipe bends and boreholes 31 to the fuel injectors are then individualized for each engine but may also be fabricated on the same pipe bending machine and in the same drilling shop. The much larger number of parts thus obtained on the whole yields a further cost reduction.

The present invention is not limited to the exemplary embodiments described here.

1-10. (canceled)

11. A fuel distributor for a fuel injection system of a mixture-compressing spark ignition internal combustion engine, the fuel distributor comprising:
a tubular base body;
a first holder connected to the tubular base body at a first fastening point on the tubular base body; and
at least one second holder connected to the tubular base body at a second fastening point on the tubular base body;
wherein the tubular base body has at least one bend at least between the first fastening point and the second fastening point.

12. The fuel distributor as recited in claim 11, wherein the tubular base body has exactly one bend between the first fastening point and the second fastening point.

13. The fuel distributor as recited in claim 11, wherein the tubular base body has a first bend and at least one second bend between the first fastening point and the second fastening point, the second bend being curved in a direction opposite to the first bend.

14. The fuel distributor as recited in claim 13, wherein the tubular base body has a straight section between the first bend and the second bend.

15. The fuel distributor as recited in claim 13, wherein the tubular base body has a third bend between the first fastening point and the second fastening point; the second bend is situated between the first bend and the third bend, and the first bend and the third bend are curved in the same direction.

16. The fuel distributor as recited in claim 11, wherein at least one of: i) the tubular base body has a straight section at the first fastening point, and ii) the tubular base body has a straight section at the second fastening point.

17. The fuel distributor as recited in claim 11, wherein no additional holder is connected to the tubular base body between the first fastening point and the second fastening point.

18. The fuel distributor as recited in claim 11, wherein the first holder is connected to the tubular base body at the first fastening point via a first connecting section, the second holder is connected to the tubular base body at the second fastening point via a second connecting section, a first fuel channel is formed which opens from a fuel chamber of the tubular base body into an interior of the first holder, and a second fuel channel is formed which opens from the fuel chamber of the tubular base body into an interior of the second holder.

19. The fuel distributor as recited in claim 18, wherein a first cup is provided, which is inserted partially into the interior of the first holder, and a second cup is provided which is inserted partially into the interior of the second holder.

20. The fuel distributor as recited in claim 11, wherein at least one of: i) the tubular base body is designed as a tubular base body bent in a meandering pattern, and ii) at least one additional holder is provided which is connected at least indirectly to the tubular base body at at least one fastening point of the tubular base body.
